(19) United States
(12) Patent Application Publication
(10) Pub. No.: US 2006/0095461 A1
(43) Pub. Date: May 4, 2006

(54) System and method for monitoring a computer environment

(76) Inventor: Robert L. Raymond, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/980,951

(22) Filed: Nov. 3, 2004

(51) Int. Cl. G06F 7/00

(52) U.S. Cl. 707/102

(57) ABSTRACT

A system and method are provided for monitoring a computer environment using a customized visual display. The method includes the operation of loading a computer environment diagram having graphic elements representing logical units of the computer environment. The graphic elements can be defined by a user of the computer environment. An additional operation is supplying attributes for the graphic elements in the computer environment diagram as defined by a user. The attributes for the graphic elements can be linked with the monitoring processes from a management layer. Another operation is changing the attributes of the graphic elements based on input received for the graphic elements from the monitoring processes. The computer environment diagram can then be modified and displayed to a user in response to data passed to the graphic elements from the monitoring processes through the graphic element attributes.

### FIELD OF THE INVENTION

The present invention relates generally to monitoring a computer environment.

### BACKGROUND

Business and organization computing systems have become large and complex. In order to manage expansive computing systems, management applications have been developed to allow an organization to monitor the performance of computing infrastructures. Real-time knowledge about a computing system helps system administrators and information managers anticipate and correct problems before the problems become critical. In addition, applications for managing computing systems help automate and manage system changes as the changes happen.

Many organizations use management applications as a part of their information technology (IT) environment. A management application can have a primary interface that includes a centralized console to monitor computing system events for the enterprise hardware and software systems. Such management applications enable customers to monitor and control interconnected computing components, operate resources from one single console, and provide information for IT management decisions. These management applications also help customers manage their computing systems by understanding and managing the dependencies between computing components and their related infrastructure.

A management application can centralize the reporting of system failures or warnings, and correlate the events with the IT service providers and customers affected by the event. Managers and system administrators can be notified by alerts and management events. In addition, predefined thresholds and exceptions can be set so that system administrators receive alerts when certain parameters are met or crossed. The alerts can be sent via e-mail or displayed on screen to help notify management when the availability of a computing system, application, subsystem, or component is in jeopardy. System administrators can act on a problem as soon as the alert appears and other users with a view of the resource can see when a problem is being addressed.

Business systems typically span the Internet, wide area networks (WANs), local area networks (LANs), and client/server or host environments. In addition, there are many interconnected applications which rely on assorted middleware, databases, operating systems, and servers. A management application or system provides centralized management and control for computing operations.

Monitoring applications generally provide tools to assure valuable monitoring and multi-platform management of heterogeneous environments. A management application can help manage computing systems by displaying dependencies between computing system components and their underlying infrastructure. In addition, management applications can show which computing systems are affected by outages and potential outages. This allows information technology (IT) staff to prioritize and plan work in response to a level of impact to the business organization.

These management applications are structured to correspond with underlying hardware systems and low-level application monitoring processes that are in place. The management applications tend to communicate information to the system administrator or end user in the same format as the application detects the environment hardware and software. The management applications generally view the world in terms of very granular hardware and software components. As a result, the output for the system administrator or end user is typically tied to monitoring that can be performed by the hardware or software directly.

In contrast, system administrators have a more abstract mental model of the enterprise computing system they manage. In other words, the system administrators logically view the enterprise computing system and associated networks differently than they are physically organized or viewed by the management application. The system administrator's model is based in part on priorities set by the business organization and the business structure of the enterprise. This mental model of the enterprise computing system in the mind of system administrator helps the system administrator monitor critical parts of the computing systems.

Because of the disparity between the physical model represented by the management application and the abstract mental model of the system administrator, it can take a considerable amount of extra effort for the system administrators to reconcile their view of the enterprise computing system with business priorities. For example, a system administrator may make a paper list of events or attributes being monitored by the management application that contribute to the overall health of priority business systems. Then the system administrator can check these events at periodic intervals. Unfortunately, this method of tracking important events and attributes is tedious and may contribute to a system administrator missing serious problems as they develop.

### SUMMARY

A system and method are provided for monitoring a computer environment using a customized visual display. The method includes the operation of loading a computer environment diagram having graphic elements representing logical units of the computer environment. The graphic elements can be defined by a user of the computer environment. An additional operation is supplying attributes for the graphic elements in the computer environment diagram as defined by a user. The attributes for the graphic elements can be linked with the monitoring processes from a management layer. Another operation is changing the attributes of the graphic elements based on input received for the graphic elements from the monitoring processes. The computer environment diagram can then be modified and displayed to a user in response to data passed to the graphic elements from the monitoring processes through the graphic element attributes.

### BRIEF DESCRIPTION OF THE DRAWINGS

FIG. 1 is a block diagram illustrating elements contained in a system for monitoring a computer environment using a customized visual display, in accordance with an embodiment of the present invention;

FIG. 2 is a block diagram illustrating an embodiment of a system for monitoring a computer environment and the underlying hardware and software components used in the system;

FIG. 3 illustrates an embodiment of graphical user interface for a customized visual display; and

FIG. 4 is a flowchart illustrating operations for monitoring a computer environment using a customized visual display.

### DETAILED DESCRIPTION OF EXAMPLE EMBODIMENT(S)

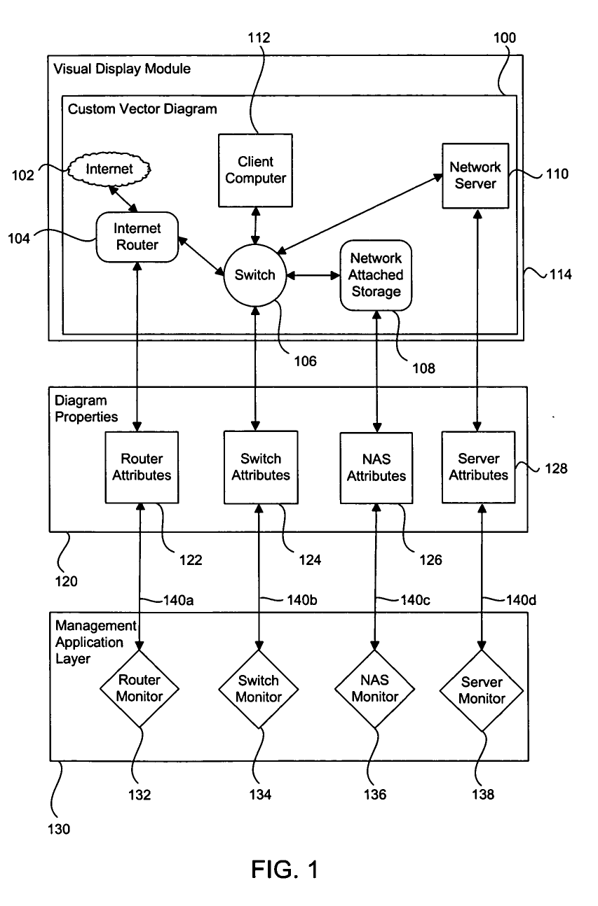

The present invention is a system and method for monitoring a computer environment having a user customized visual display. Particularly, the computer environment to be monitored may be a networked computer system containing a number of networked computing components, storage components, servers, client computers, and other computing devices. FIG. 1 illustrates an embodiment of the system that includes a custom vector diagram 100 that has graphic elements 102-112 representing logical units of the computer environment. In this context, the term custom vector diagram means that the diagram is created by a user independently of a management application. The user can create a custom vector diagram using a graphics or illustration tool that generates a vector output. In addition, the user may use a drawing tool which can produce graphic elements with data attributes. For example, an illustration program can be used such as Adobe Illustrator®, Canvas®, Microsoft Visio®, or any similar drawing tool that can output a vector graphics file to create the custom vector diagram.

In FIG. 1, an example vector diagram is illustrated with graphic elements or graphic network objects that represent the Internet 102, an Internet router 104, a client computer 112, a switch 106, a network attached storage 108, and a network server 110. Of course a myriad of other elements may be represented that can be used in the network computer environment. For example, printers, gateways, firewalls, web servers, mail servers, and other computing devices may be represented as needed. In addition, computer environments may contain multiples of each computing component.

While this custom vector diagram is illustrated as representing more discreet components, a more abstract custom vector diagram may also be created. For example, a single block such as the Internet router 104 can be a representation of a plurality of routers or a single graphic element may be provided to represent all routers, switches, and gateways on a network. Moreover, one network server element 110 may represent large racks of web servers that are desired to be viewed as a group. This allows the network administrator to look at groups of logical items and then analyze from a high level point of view whether those groups are acting as they should be. Disparate objects can be combined in a group if they are part of the business process. For example, an e-commerce diagram may report on a web server, mirror server, gateway, and router using a single graphic element.

In highly complex corporate and other large scope computing environments, it is valuable for the network administrators and system analysts to be able to quickly see the overall status of elements in the computing environment and form certain logical, organizational, geographical, or business driven groupings. For example, an e-commerce system may provide graphic elements that illustrate the health of critical e-commerce components to a company. Alternatively, other systems may rely heavily on compute intensive applications, and thus the status for a main frame, a group of vector processors or other computationally intensive equipment, may be monitored using graphic element diagrams.

FIG. 1 illustrates that a plurality of diagram attributes and/or properties 120 can be provided for each of the graphic elements that is representing a computer environment. As mentioned, the graphic elements can be defined by the users of the custom vector diagram. In addition, the end user can define one or more attributes or properties that are associated with each graphic element. This is illustrated by the attributes 122-128 in FIG. 1. Each graphic element may include one or more lines, curves, etc., to form what represents or even resembles a network computing component. The attributes are also connected to defined visual aspects or other reporting aspects of the graphic elements in a user defined way.

Since each graphic element will have its own visual attributes, this allows each graphic element or visual object to be modified differently. For example, FIG. 1 illustrates that the Internet router 104 has router attributes 122. When the visual attributes are changed for the Internet router, the changes to the attributes can be represented in the viewable graphic elements for the Internet router (or group of Internet routers) to be modified. For instance, the Internet router graphic element may change color or otherwise be modified to represent to the end user that there is a problem occurring with the Internet router. Attribute changes may also be reflected by the graphic elements in order to show improvements or other statuses of the Internet router as needed. The diagram properties 120 illustrate that each of the vector graphic elements can have attributes and properties that can be modified by the end user.

A plurality of management application objects 132-138 or monitors can be provided for monitoring the computer environment status. These monitoring tools include monitors for the network hardware and software as configured via the underlying management application. The management application objects may include hardware monitoring systems such as SNMP (Simple Network Management Protocol) or other similar network, hardware, and software management tools. The management application objects, such as the hardware/firmware monitors illustrated, are in communication the physical hardware and layers of software for the computing environment. For simplification purposes, the hardware and software layers being monitored in FIG. 1 are not shown but they can interface with the management application layer 130. In addition, the present invention allows the management computing environment to leverage the previously installed base of monitoring products that are already being used within a computing environment.

In FIG. 1, an embodiment of a system of the present invention is illustrated where each graphic element has attributes that map to one or more hardware or software monitors. For example, the Internet router 104 includes router attributes 122 and these attributes are mapped to at least one hardware or software router monitor 132. In addition, each graphic element may have multiple hardware and software monitors that feed into the attributes and result in the final visual appearance of the graphic elements representing Internet router.

The management application layer can include many types of different management application layers that exist presently. For example, Hewlett Packard's OpenView can be used to set up the hardware or software monitors and to monitor the overall network status. Such products have been used in the past to provide the status at the very granular level of the hardware and individual components.

A plurality of links 140a-d (e.g., data links) are configured for linking the attributes of the graphic elements 122-128 and the management application objects 132-138. The links enable the attributes to be modified based on the output received from the management application objects. In turn, the modification of the attributes changes the visual appearance and other qualities of the graphic elements in the custom vector diagram. These links allow the custom graphic elements in the vector diagram to be dynamically connected to the management application layer. Then the data coming from the hardware and software monitors can automatically be transferred to the attributes which results in periodic electronic updates to the viewable graphic elements. The updates may take place at an interval defined by a user.

The system of the present invention can further include a visual display module 114 that is configured to display the custom vector diagram. This visual display module or rendering module can display and update the custom vector diagram displayed to users in response to the data received from monitoring processes for the attributes of the graphic elements. In other words, the visual display module may be a stock rendering engine which can output the vector graphic diagram.

As discussed previously, the graphic elements can be configured to be modified based on changes that occur to the attributes. The graphic elements may change colors, size, shading, or shape in response to attribute data received through the linked outputs from the monitoring processes. For example, if an Internet router or server monitor sends attribute data representing a hardware failure, then the user may have defined the object to turn red or another warning color. Alternatively, if only one element of a multiple router group is having a problem, then the graphic element may be defined to turn yellow or brown. If everything is fine for the router(s), then the graphic element may display green or plain white.

The graphic elements may also use graphical overlays that are “overlaid” or applied to the graphic elements. In the embodiment where a graphic element is represented as a two-dimensional object, a message bubble may be overlaid on the graphic element to represent that there has been a failure in a network component or computing component. Alternatively, there may be a different shape that surrounds the vector graphic element or some other type of informational shape overlay that can be used.

Another example of using an overlay is where an icon overlay may be provided. Specifically, an icon overlay may include an exclamation point, a red question mark, a happy face, a cloud, or some other symbolic or pictorial icon that represents a change in the computer environment being monitored. Other types of overlays for two-dimensional or three-dimensional graphic element representations can also be used with the present invention.

In addition to using a graphical icon to represent change, the user can define audio, video, or animated outputs that are tied to attributes of the graphic elements. In one embodiment, the user can combine an attribute of a graphical element together with an audio warning file, a clip of music, or an audio effect to represent a change in the monitored computing environment.

As described previously, a vector graphics format can be used to define the graphic elements in the computer environment. The vector graphics format can be output into a stored file by the user's graphics format authoring tool along with the attributes for the graphic elements. Accordingly, when the present invention is initiated, dialog boxes may be provided to locate a vector graphics file. One valuable format that can be used for the vector graphics output is a structured vector graphics (SVG) format. This is a valuable format because many graphics and illustration tools support this pre-defined standard for the graphics community. SVG is an XML dialect or subset that describes a diagram as a tree of drawing elements such as lines, text, triangles and arcs. In addition, another graphics format may be used by the present invention as long as the format can be used to generate a custom diagram. For example, the proprietary graphics format provided by Visio can be used because the graphical objects or elements can be created along with attributes. Other possible formats may include bitmaps, JPEGs, TIFFs or other image formats to represent computer environment components.

The links or data connections between the management application objects (or monitors) and the attributes contained in the custom vector diagram may be stored in any of a number of storage locations. In one embodiment of the invention, a storage structure for storing the links can be contained within the custom vector diagram file. This storage structure can be saved on nonvolatile storage with the custom vector diagram file.

Alternatively, a separate diagram “view” file can be generated which stores the links between the attributes and the management application objects. In other words, the links between the attributes and the monitoring processes may be stored in their own separate file and may be loaded by the management application separately from the custom vector diagram. Using a view file allows the graphic elements to be modified by the end user without affecting the links view. Logic may be provided to verify the connections between the graphic elements, attributes and links, and if graphic elements or attributes are deleted then the corresponding links can be deleted. If a user modifies the custom vector objects and the attributes associated those objects, then the user may desire to manually reconfigure the links appropriately. The association between the mappings or links and the diagram is more efficiently managed when the user is allowed to modify the visible graphical portion of the diagram without destroying the links or mappings underneath as with diagram view files.

In another embodiment of the invention, a group identification (GID) can be associated with each graphic element or group of elements. This group identification GID can be used to link the monitoring processes or objects together with the graphic element attributes. This configuration also allows visual or audio portions of the graphic elements to be modified while maintaining the underlying data integrity between the link and the attributes.

The present invention is valuable because it allows end users to apply common illustration and diagramming tools that can save information into a vector format or a structured vector format. This allows the end user to use their preferred graphics editor to logically map a computer environment as long as the graphics editor can save diagrams in vector format or another format usable by the present invention. The ability to customize diagrams provides flexible grouping mechanisms to display the real-time status related to business organizations, departments, regions, and sets of similar or dissimilar resources. In addition, the custom vector diagrams can express relationships in organizations, physical architectures, computational architectures, and layout.

Another reason why this invention is valuable is that enterprise management applications in the past have typically provided visualizations of the underlying low-level computer environment and electronic components as the management application views and detects the components. For example, network management application tools can auto-detect that network components exist on the network but the components are recognized at a detailed hardware level in the way that the hardware views itself. Unfortunately, network or computing environment maps that are automatically discovered do not provide any actual organizational, business structure, or similar information. These auto-detected hardware diagrams simply provide a highly technical view which greatly reduces the value of automatically recognizing components.

In contrast, most system administrators or end users have a high-level mental model of the computing environment. Allowing the system administrator to create an active diagram of the management data in a way that matches the network administrator's mental model allows network administrators to the see the management application data as they desire to see it. This improves the network administrator's high speed comprehension and cognitive understanding of the computing environment and allows for more complex mental visualizations. In addition, this custom modeling is useful because humans have many cultural, organizational, and higher level understandings of physical systems that are used in human interpretation of computing environments.

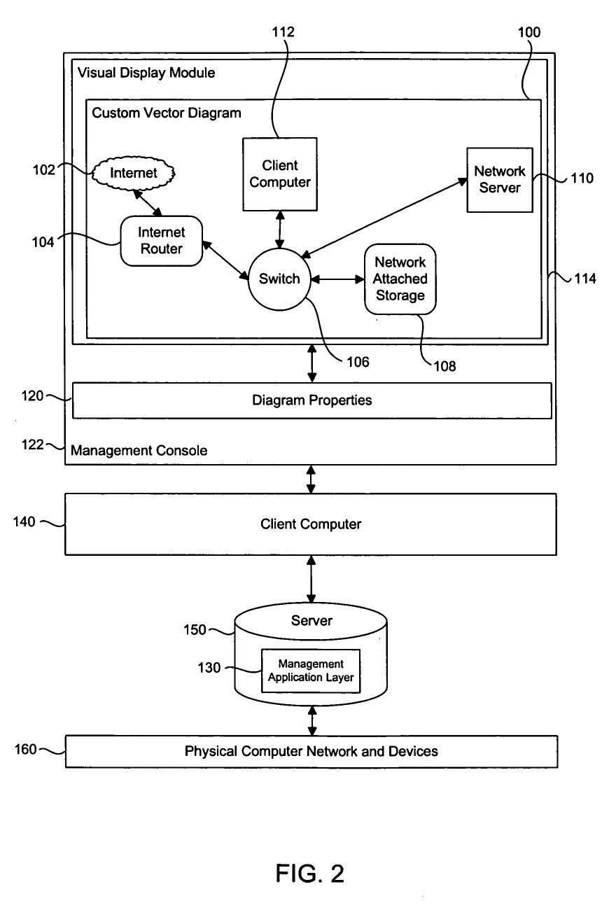

FIG. 2 depicts a higher level description of an embodiment of a system for monitoring a computer environment having a user customized visual display. Particularly, this figure illustrates the relationship of the visual display module 114 to the overall network and related computer hardware components. Specifically, the visual display module, custom vector diagram 100 and graphic elements 102-112 can be part of a management console 122 that is used for managing and troubleshooting a network. The visual display module can either contain diagram properties or interact with a diagram properties module 120 that contains the properties for the visual elements. The management console can execute on a client computer 140 that has an operating system. In addition, the client computer or workstation can be connected to a server 150 that executes a management application layer 130. Alternatively, the management application layer can reside on the client computer with the management console. The management application layer is in communication with the physical network 160 and devices that are connected to the network. The physical network can contain elements such as routers, switches, hubs, servers, gateways, network attached storage (NAS) and similar networking components.

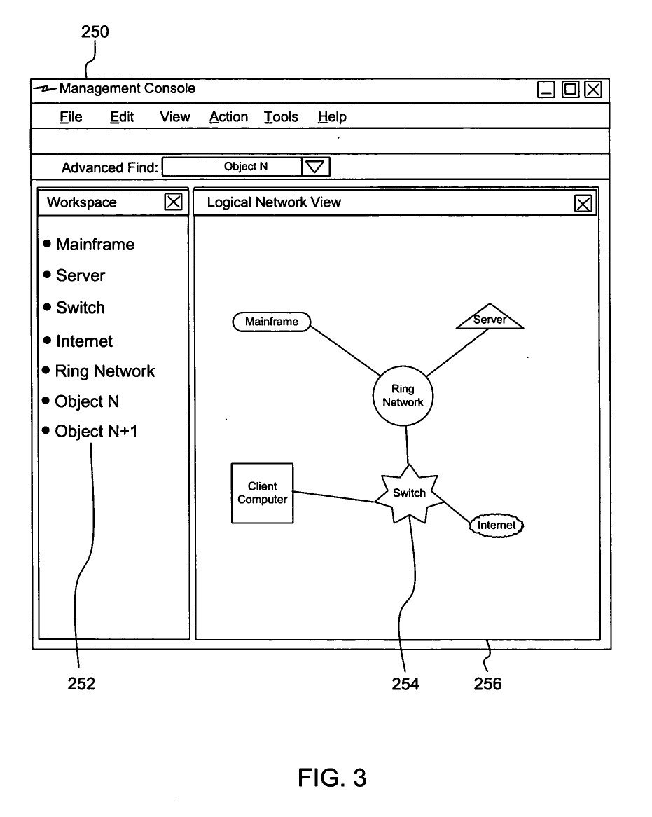

FIG. 3 illustrates a graphical interface 250 for the management application in which a vector diagram user interface screen 256 is shown. In order to load the custom vector diagram, the user will be presented with a dialog box window through which the user can locate to a copy of the custom vector diagram stored on a nonvolatile storage system (e.g., hard drive, Flash RAM, etc). The dialog box can contain interface controls or fields that let the user specify the URL address or storage location of the custom vector diagram. For example, a user can load a network diagram showing a number of network objects 254, such as servers, routers, switches, and hubs using the illustration or diagramming tool.

When the graphic elements are loaded from the vector diagram file, the user may be prompted to link the graphic elements together with hardware and software management objects or monitors. The user can then associate specific monitoring messages, actions, or operations from the management application objects together with the graphic element attributes.

Alternatively, when the user or network administrator clicks on a graphic element that is not associated with a management application object or monitoring process, then a context menu can be displayed for the object with an entry prompting a user to “Map to Monitoring Process”. Clicking on this menu will bring up a management application object selection dialog.

Windows or graphical panes showing the attributes and associated property information for each graphical element can be accessed through a work space 252 selection area. This allows the name of the graphical element or logical grouping of objects to be clicked on and then the attributes and associated properties with those objects may be individually displayed.

In one embodiment of an interface screen, there can be two customization dialog boxes. One customization dialog box can define and enable the control of a refresh method for the entire vector diagram. For example, the vector diagram can be refreshed at certain time intervals of thirty seconds, one minute, ten minutes, etc. Another customization dialog box may be called the “Diagram View Properties”. This dialog box may include graphical controls to enter information such as text, numbers, masks, or alphanumeric fields.

In addition to the more detailed visualizations provided by the present invention, additional abstractions can be provided by a user. Not only can server objects be represented by a line item or a box or some other item, but any type of graphic element that can be thought of by a network administrator can be used to represent a server or other electronic components. For example, if the user desires to represent a group of routers as a simple line, curve, crescent shape, or some other item, this very abstract configuration is possible with the present invention. As a result, many underlying network components and monitoring systems can be analyzed using very abstract shapes. Then the shapes can be colored, modified, or changed based on specific events that happen in the computing environment.

There may also be multiple vector graphics diagrams that apply to a final diagram. For instance, a master vector diagram may hierarchically be connected to one or more separate sub-diagrams. Thus, the user may have a high level diagram and be able to drill down to another lower level diagram.

The user may also modify auto-detected information from the management application to create vector objects or higher level abstractions related to the auto-detected objects. Being able to modify the graphic elements generated by the system allows for the placement of discovered resources into containers that represent critical business systems or logical organizations. In addition, the reuse and customization of the management application's auto-detected information reduces the implementation time of end user diagrams, reduces errors, and ensures the relevance and accuracy of the management view.

In an alternative embodiment, the management application can infer some attributes or mappings for common network components in the diagram. This is more likely for network diagrams where the user may store identity information like an IP address or a network name as an attribute of the diagram element. These properties may appear as Microsoft extensions to the structured vector graphics format for the exported diagrams. This is effective with Visio diagrams where these elements map more easily. For instance, the network user may retrieve the IP address and use the network retrieved status for the network components. This auto-detection mechanism is not as valuable as the final user customized diagram because it more closely tracks the low-level structure provided by the network itself or the management application, but this can be a good starting place for the final abstract diagram.

Once the vector diagram is loaded, the diagram can be rendered in the vector diagram user interface screen 256. Right clicking on the diagram can bring up a context menu. The context menu will depend on the object 254 it is over. When the user interface pointer (i.e., mouse pointer) is located over an object that is already linked to a monitoring object in the management application object, then a context menu item can be brought up. The context menu may be defined based on the type of computer component or abstract management construct the graphic element is designed to reflect. For example, there may be certain standard contexts that are provided for routers, server groups, or other components. The context may include things such as a network tree, an active directory group, or some other logical context that is created by user.

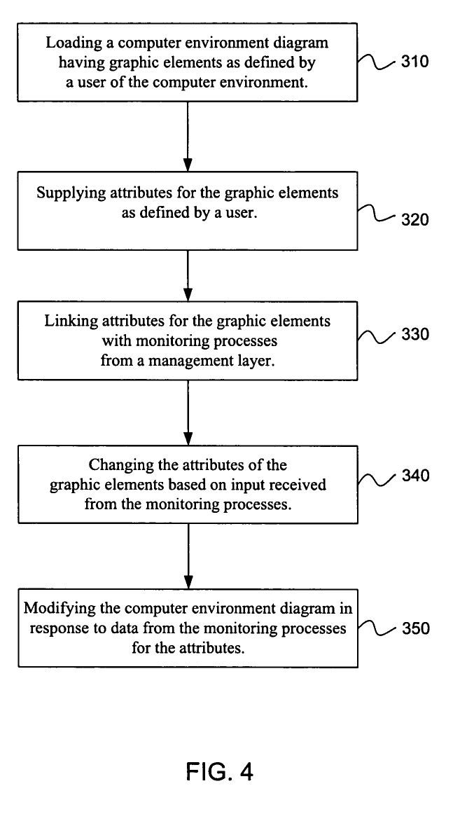

The present invention includes an embodiment of a method for monitoring a computer environment using a visual display as illustrated in FIG. 4. The method can include a number of operations for monitoring a computer network and its related computing environment. One operation in the method can be loading a computer environment diagram having graphic elements representing logical units of the environment as in block 310. These graphic elements can be defined by a user or network administrator of the computer environment. The computer environment diagram can be loaded from a vector graphics file or structured vector graphics (SVG) file. Such a file can be stored on a hard drive, a nonvolatile memory, a network server, or in another location.

Another operation can be supplying attributes for the graphic elements in the computer diagram defined by a user as in block 320. The attributes can be created by a user and assigned to selected graphic elements. Upon loading, the attributes can be extracted from the vector graphics file or from a separate diagram view file. Thus, each graphic element will have one or more attributes (and/or properties) assigned to it. Each of these attributes can contain values such as numerical values, alphabetic values, error messages, or other information.

Once the computer environment diagram has been loaded, the diagram can be displayed. The user may be prompted to link the attributes for the graphic elements with monitoring processes or management application objects as in block 330. When the user is prompted to link these attributes together, the user will be provided with a dialog box capable of associating low-level hardware and/or software monitoring processes with the given graphic elements. A further operation is changing the attributes of the graphic elements based on input received from the monitoring processes as in block 340. This means that modification information can be received from the monitoring process regarding the status of certain hardware. For example, a network server may have SNMP hardware and software processes that monitor the network server. When there is a problem with the network server, the hardware or software process is activated to send a message to the management console. The management console can forward this information to the custom vector diagram via the user created links and then modify the attributes of the graphic elements accordingly. This in turn will result in a modification to the computer environment diagram display. The diagram display changes in response to data passed to the object attributes from the monitoring processes through the object attributes as in block 350.

In addition to the attributes provided for the graphic elements in the computer environment diagram, the graphic elements may have a selected context in the computer environment diagram that can be viewed by the end user. The user may apply a context to the graphic elements. For example, the context may be that the graphic element represents an electronic component located on a certain segment of a network, is part of a certain active directory group, or is part of a business unit. Such context can not be provided by a management application but can only be provided to an end user because of the business and organizational information known by the user.

As described previously, when changes are made to the attributes of the graphic elements, this can result in a number of visual changes. For example, the graphic elements may change color, size, receive graphical overlays, include message bubbles, icon overlays, changes in text information or similar updates. These updates signal to a network administrator or end user that there is a problem that may need to be addressed.

In summary, the present invention provides business context for information technology managers, system administrators and other end users. Greater accountability for the computing system is linked to the business' needs and this in turn improves the system administrator's ability to prioritize and optimize computing systems. A user customizable graphics diagram also helps managers understand which business systems are impacted by resource outages. The system and method of the present invention also allows information technology staff to view computing resources in the context of critical business services and allows them to prioritize actions based on business impact. Intelligent tradeoffs can also be made when the appropriate context is presented to system administrators.

The present invention also allows system administrators to more easily spot inefficiencies, problems, and quickly diagnose the root cause of complex failure scenarios. The display of near instantaneous or real-time service level status in combination with a custom user diagram aids in increasing the availability of critical business systems.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method for monitoring a computer environment using a customized visual display, comprising the steps of:
loading a computer environment diagram having graphic elements representing logical units of the computer environment as defined by a user of the computer environment;
supplying attributes for the graphic elements in the computer environment diagram as defined by the user;
linking the attributes for the graphic elements with monitoring processes from a management layer;
changing the attributes of the graphic elements based on input received for the graphic elements from the monitoring processes; and
modifying the computer environment diagram displayed to the user in response to data passed to the graphic elements from the monitoring processes through the graphic element attributes.

2. A method as in claim 1, further comprising the step of supplying a selected context for the graphic elements in the computer environment diagram as defined by the user;

3. A method as in claim 1, further comprising the step of displaying changes to attributes of the graphic elements by changing colors, sizes, or shapes of the graphic elements.

4. A method as in claim 1, further comprising the step of indicating changes to the attributes of graphic elements using graphical overlays for the graphic elements.

5. A method as in claim 4, further comprising the step of indicating changes to the attributes of graphic elements using graphical overlays selected from a group of message bubbles, shape overlays, and icon overlays.

6. A method as in claim 1, further comprising the step of using a vector graphics format to define the graphic elements displayed in the computer environment diagram.

7. A method as in claim 6, further comprising the step of using a structured vector graphic (SVG) format to define the graphic elements in the computer environment diagram.

8. A method as in claim 1, further comprising the step of loading the computer environment diagram from a vector graphics file selected by the user.

9. A method as in claim 1, wherein the step of loading the computer environment diagram, further comprises the step of creating the computer environment diagram having graphic elements representing logical mappings of physical entities in the computer environment as defined by the user of the computer environment.

10. A method as in claim 1, further comprising the step of storing links between the attributes of the graphic elements and monitoring processes in a diagram view file.

11. A method as in claim 1, further comprising the step of storing links between the attributes for the graphic elements and the monitoring processes from the management layer with the computer environment diagram.

12. A method as in claim 1, wherein the computer environment is a networked computer environment.

13. A system for monitoring a computer environment, comprising:
a computer environment diagram having graphic elements representing logical units of the computer environment, the logical units being defined by a user of the computer environment;
a plurality of attributes for each of the graphic elements in the computer environment as defined by the user;
a plurality of management application objects configured for monitoring computer network components; and
a plurality of links configured for linking the attributes of the graphic elements to the management application objects, wherein the links enable the attributes to be modified based on input received from the management application objects which in turn modifies viewable output of the computer environment diagram.

14. A system as in claim 13, further comprising a visual display module configured to display the computer environment diagram and modify the computer environment diagram displayed to the user in response to data received for the attributes of the graphic elements from monitoring processes in a management layer.

15. A system as in claim 14, wherein the graphic elements are configured to change colors in response to linked inputs from the monitoring processes.

16. A system as in claim 14, wherein the graphic elements are configured to receive graphical overlays in response to linked inputs from the monitoring processes.

17. A system as in claim 16, wherein the graphic elements are configured to accept graphical overlays selected from a group of message bubbles, shape overlays, and icon overlays.

18. A system as in claim 13, further comprising a vector graphics format to define the graphic elements in the computer environment diagram.

19. A system as in claim 18, wherein the vector graphics format is a structured vector graphics (SVG) format diagram that defines the graphic elements in the computer environment diagram.

20. A system as in claim 13, further comprising a file containing the computer environment diagram, wherein the file can be loaded from a storage system.

21. A system as in claim 13, further comprising a storage structure in the computer environment diagram for storing the links between the attributes and management application objects.

22. A system as in claim 13, further comprising a diagram view file configured for storing the links between the attributes and the management application objects, wherein the diagram view file is separate from a computer environment diagram file.

23. A system as in claim 22, further comprising a group identification (ID) associated with each graphic element for creating with a link to a monitoring process in order to enable a graphic element to be modified while maintaining the data integrity of the link.

24. A system as in claim 13, wherein the computer environment diagram is a master vector diagram with at least one hierarchically connected vector sub-diagram.

25. A system for monitoring a computer environment using a customized visual vector based display, comprising:
a custom vector diagram means having graphic elements means for representing logical units of the computer environment, the logical units being defined by a user of the computer environment;
a plurality of attributes means for storing data related to the graphic elements in a computer environment as defined by the user;
a plurality of management application object means for monitoring computer network hardware and software; and
a plurality of links means for linking the attribute means of the graphic elements and management application object means, wherein the link means enable the attributes means to be modified based on output received from the management application object means which in turn modifies viewable output of the custom vector diagram means.

26. A system as in claim 25, further comprising a visual display means for displaying a computer environment diagram and modifying the computer environment diagram displayed to the user in response to data received for the attributes of the graphic elements from monitoring processes in a management layer.

27. An article of manufacture, comprising:
a computer usable medium having computer readable program code embodied therein for monitoring a computer environment using a customized visual display, the computer readable program code in the article of manufacture, comprising:
computer readable program code configured to load a computer environment diagram having graphic elements representing logical units of the computer environment as defined by a user of the computer environment;
computer readable program code configured to supply attributes for the graphic elements in the computer environment diagram as defined by the user;
computer readable program code configured to link attributes for the graphic elements with monitoring processes from a management layer;
computer readable program code configured to change the attributes of the graphic elements based on input received for the graphic elements from the monitoring processes; and
computer readable program code configured to modify the computer environment diagram displayed to the user in response to data passed to the graphic elements from the monitoring processes through graphic element attributes.

28. An article of manufacture as in claim 27, comprising computer readable program code configured to use a vector graphics format to define the graphic elements displayed in the computer environment diagram.
